(19) United States
(12) Patent Application Publication
(10) Pub. No.: US 2022/0104505 A1
(43) Pub. Date: Apr. 7, 2022

(54) Freezer-To-Oven Dough Product Having Reduced Cook Time

(71) Applicant: General Mills, Inc., Minneapolis, MN (US)

(72) Inventors: Steven J Cox, Long Lake, MN (US); David J Domingues, Plymouth, MN (US); Michael Freeman, Robinsdale, MN (US)

(73) Assignee: General Mills, Inc., Minneapolis, MN (US)

(21) Appl. No.: 17/065,029

(22) Filed: Oct. 7, 2020

(51) Int. Cl. A21D 8/02; A21D 6/00; A21D 10/02

(52) U.S. Cl. CPC A21D 8/02; A21D 10/02; A21D 6/001

(57) ABSTRACT

A frozen topologically modified dough product is produced by creating topological features in a dough piece having a main body portion including an upper surface and a lower surface, wherein the topological features is at least one of undulations in the upper surface created through formation of a series of crest and trough regions and a series of tunnels created in the main body portion of the dough piece, and then freezing the dough piece to produce a frozen dough piece. When cooked, particularly through a convection baking operation, the topological features increase the surface area for convection heat transfer during the baking operation, resulting in a significantly reduced overall bake time.

### FIELD OF THE INVENTION

The invention pertains to the art of food production and, more particularly, to the mass production of freezer-to-oven dough products which are structured to provide for reduced cook times.

### BACKGROUND

A number of methods have been employed in order to make various types of bread products, such as loaves, buns, rolls, biscuits, and breadsticks, from a sheet of dough. In commercial systems, a sheet of bread dough may typically be extruded, reduced and provided to a conveyor which conveys the sheet of dough along a dough travel path. The sheet of dough then encounters one or more cutting apparatus, such as slitter wheels, guillotine-type cutters, reciprocating head cutters, rotatable drum-type cutters or the like. The resulting dough products can then be frozen and shipped for resale, such as to grocery stores for purchase directly by consumers, restaurants, bakery stores, or the like.

Regardless of the destination, the frozen dough product must be cooked prior to consumption. When looking to bake frozen dough products, it is common to initially thaw the dough products prior to baking. However, it is also known to have frozen dough products which are intended to go directly from a freezer to an oven, i.e. freezer-to-oven (FTO) dough products. Certainly, the baking times increase when the frozen dough products are not thawed prior to baking.

Whether in a domestic or commercial setting, it would be preferable to minimize the cooking time, so long as the reduction could be done without significantly degrading the quality of the resulting baked dough product. Particularly with freezer-to-oven (FTO) dough products, there is an overall desirability to be able to produce an FTO dough product which mimics both the visual and taste characteristics of fresh baked dough products, while being easier to produce. Of course, even more advantageous would be an FTO dough product which presents both reduced bake times and visual/taste enhancements.

### SUMMARY OF THE INVENTION

The invention is directed to producing freezer-to-oven dough products which have been processed to result in topological features that functionally reduce required cooking times. In accordance with one embodiment of the invention, a frozen dough product is produced with undulating upper surfaces through the formation of a series of crest and trough regions which increase the overall surface area of the upper surface. During baking, the added surface area promotes heat transfer, particularly convective heat transfer, upon baking, thereby resulting in reduced bake times. This topology change also advantageously results in dehydrated, crispy ridges upon baking, thereby desirably resulting in a dual textured baked dough product.

In accordance with another embodiment of the invention, the topological features take the form of a series of tunnels created in the dough product prior to freezing. Most preferably, the dough product is, at most, only partially fermented such that the dough product expands during cooking. When baking, the tunnels increase the effective surface area for enhanced convective heat transfer purposes, while the tunnels are effectively sealed during the baking operation due to the expansion of the dough product during cooking. Therefore, this arrangement not only enables the reduced cook times desired in accordance with the invention, but desirably results in a more internally expanded and airy final baked dough product, i.e., a final baked dough product which is lower in density and higher in quality.

Certainly, both the surface undulation and tunneling aspects of the invention can be employed individually or in combination in connection with the overall invention. In any case, additional objects, features and advantages of the invention will become more readily apparent from the following detailed description of the embodiments when taken in conjunction with the drawings wherein like reference numerals refer to corresponding parts in the several views.

### BRIEF DESCRIPTION OF THE DRAWINGS

FIG. 1 illustrates a dough product forming apparatus used to make dough products in accordance with a first embodiment of the present invention;

FIG. 2 is a perspective view of cooked FTO biscuit created in accordance with the first embodiment;

FIG. 3 is a perspective view of a frozen dough product made in accordance with a second embodiment of the invention; and

FIG. 4 is a graph illustrating the reduced cooking times associated with embodiments of the invention.

### DETAILED DESCRIPTION

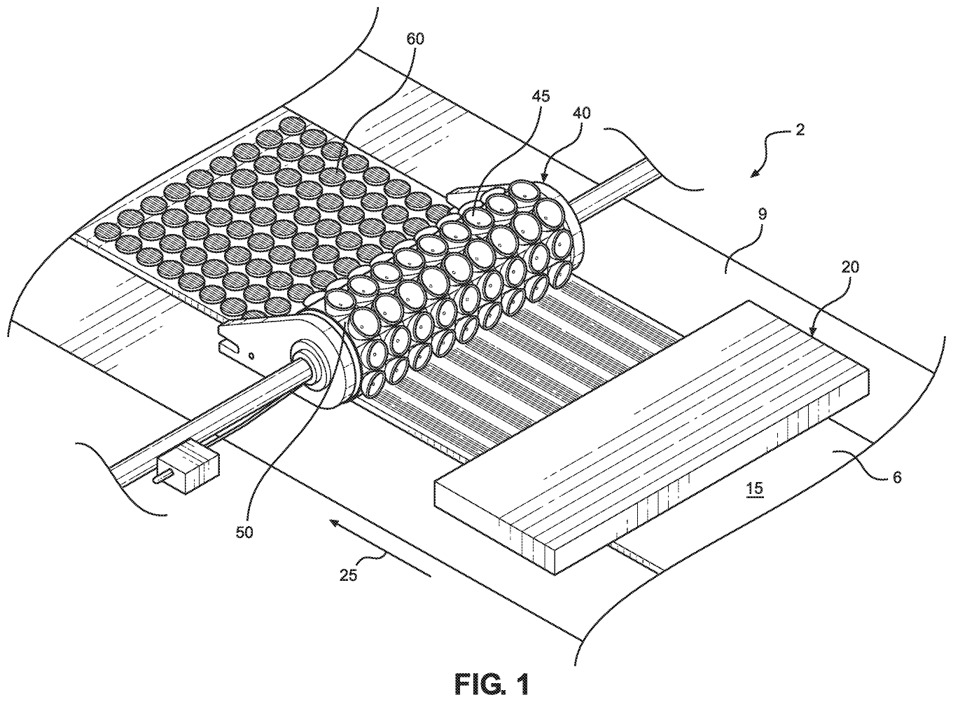

With initial reference to FIG. 1, a food product assembly line 2 for forming topologically altered, freezer-to-oven dough products in accordance with a first embodiment of the present invention is depicted. As shown, food product assembly line 2 has a sheet of dough 6 traveling from right to left upon a conveyor 9. Although not shown, it should be understood that the dough is formed in a batch maker or the like and transferred to food product assembly line 2 where it is processed into dough sheet 6 which has an upper surface 15. As dough sheet 6 moves on conveyor 9 in the direction indicated by arrow 25, dough sheet 6 is first directed through a surface modifying unit 20 which undulates upper surface 15 as will be detailed more fully below.

By way of example, in the illustrated embodiment used to make biscuits, conveyor 9 is capable of moving at a speed of approximately 60 ft/min, while supporting a dough sheet in the order of 2-3 inches (approximately 5-7.5 cm) thick. After upper surface 15 is undulated, dough sheet 9 proceeds to a dough forming and cutting apparatus 40 which, in the exemplary version shown, includes a plurality of cutter molds, one of which is indicated at 45, disposed on an exterior surface of a cylindrical, rotatably driven drum 50 for forming and cutting dough sheet 6 into a number of topologically modified biscuit pieces 60. In accordance with this illustrative form of the invention, the plurality of cutter molds 45 are mounted relative to the conveyor 9 such that, when dough sheet 6 is traveling in the direction indicated by arrow 25, cutter molds 45 engage the dough sheet 6, receive and shape the dough and sever it to provide a plurality of cuts in dough sheet 6, resulting in the formation of individual biscuit pieces 60 and intermediate, recyclable dough pieces (not shown). Drum 50 can either be positively driven, or simply driven by the frictional engagement between the cutter molds 45 and dough sheet 6 or the conveyor 9. In operation, cutter molds 45 extend all the way through dough sheet 6 to lightly engage conveyor 9 and thereby completely sever dough sheet 6. Certainly, the thickness of dough sheet 6 can be changed in accordance with the invention, with a corresponding change in the size of cutter molds 45, in order to form products of varying size (and even shape). After the cuts are made in dough sheet 6, dough sheet 6 continues traveling in the direction indicated by arrow 25 to a post processing station (not shown). However, in accordance with the overall invention, the post processing station(s) at least includes freezing and packaging of biscuit pieces 60.

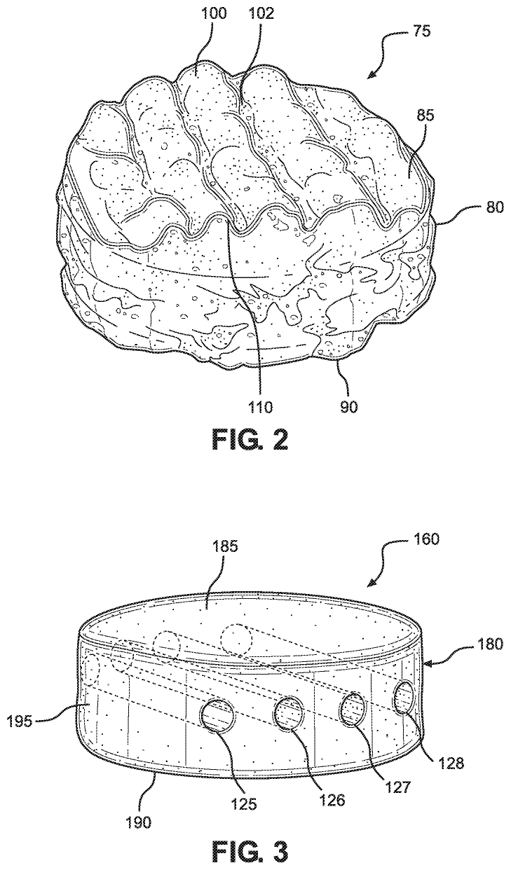

In accordance with the invention, surface modifying unit 20 increases the surface area of upper surface 15 in the order to 10-30%, preferably 15-25% and, most preferably, at least 20%, versus a conventional flat top biscuit. As will be detailed more fully below, in accordance with one benefit of the invention, this increased surface area significantly reduces the baking time for the frozen biscuit pieces 60, with this reduction being found to be in the order of 20-25% versus a conventional flat top biscuit. At this point, reference will be made to FIG. 2 which illustrates a final, baked biscuit 75 produced in accordance with the above described embodiment of the invention. More specifically, baked biscuit 75 results from baking, directly from a frozen state, a biscuit piece 60. As shown, baked biscuit 75 has a main body portion 80 including an upper surface 85 and a lower surface 90. Upper surface 85 is shown to be undulated so as to include a series of crest regions and trough regions, two of which are labeled at 100 and 102 respectively. On the other hand, lower surface 90 can be flat, particularly to obtain an even browning when biscuit 75 is baked on a baking pan, or could be scored to also be undulated. Actually, if desired, lower surface 90 could define the only undulated surface without departing from the invention. Therefore, in general, a majority of at least one surface has to be undulated in accordance with this embodiment of the invention.

In any case, with the additional surface area created by the crest and trough regions 100 and 102, the amount of dehydration of upper surface 85 is increased during baking relative to a remainder of main body portion 80. Based thereon, a crispy layer 110 is formed upon baking, with the crispy layer 110 being defined by crispy ridges and valleys corresponding to the created crest and trough regions 100 and 102. Overall, in accordance with this embodiment of the invention, a dough product is produced with undulating top and/or bottom surface through the formation of a series of crest and trough regions which increase the overall area of the surface. During baking, the added surface area promotes heat transfer, particularly convective heat transfer, thereby resulting in reduced bake times. This topology change also advantageously results in the dehydrated, crispy ridges and valleys upon baking, thereby desirably resulting in a dual textured baked dough product.

FIG. 3 illustrates another embodiment of the invention wherein the increased surface area enabling the desired reduced cook times is created by topological features in the form of the series of tunnels 125-128 provided in a dough pieces 160. More specifically, dough piece 160 has a main body portion 180 including upper and lower surfaces 185 and 190, as well as an annular sidewall 195. Tunnels 125-128 are shown to extend through main body portion 180 across annular sidewall 195. This arrangement is considered to be particularly effective for convective heat transfer in achieving the desired reduction in cook time. In addition, to achieve the desired reduction in cook time through topological modification, each of the tunnels 125-128, e.g., 3/16 inch diameter tunnels for 2 oz biscuits, extends at least 70% through main body portion 180. In even more preferred embodiments, tunnels 125-29 extend at least 90-100% through main body portion 180. Tunnels 125-128 are configured to provide for a corresponding 10-30% (as well as the preferred percentages outlined above) increase in surface area, along with a corresponding reduction in overall cook time to the first embodiment described above.

In accordance with a further aspect of the invention, dough pieces 60 and 160 are, at most, partially fermented or expanded prior to freezing. Therefore, expansion of dough pieces 60 and 160 will occur upon baking, particularly as the frozen products produced in accordance with the invention are designed to be baked directly from a frozen state, i.e., freezer-to-oven dough products. In the first disclosed embodiment having the crest and trough regions, this expansion, which is generally in the order of 1.5-3 times the volume of the originally cut dough pieces 60, accentuates the topological changes by producing pronounced ridges and valleys. In accordance with the second disclosed embodiment, this expansion actually conceals the topological changes. That is, upon expansion, tunnels 125-128 actually close, thereby becoming sealed so as to be generally, completely unnoticeable in the final baked product. However, at the same time, the main body portion becomes more light and airy, advantageously contributing to an enhanced, overall final product.

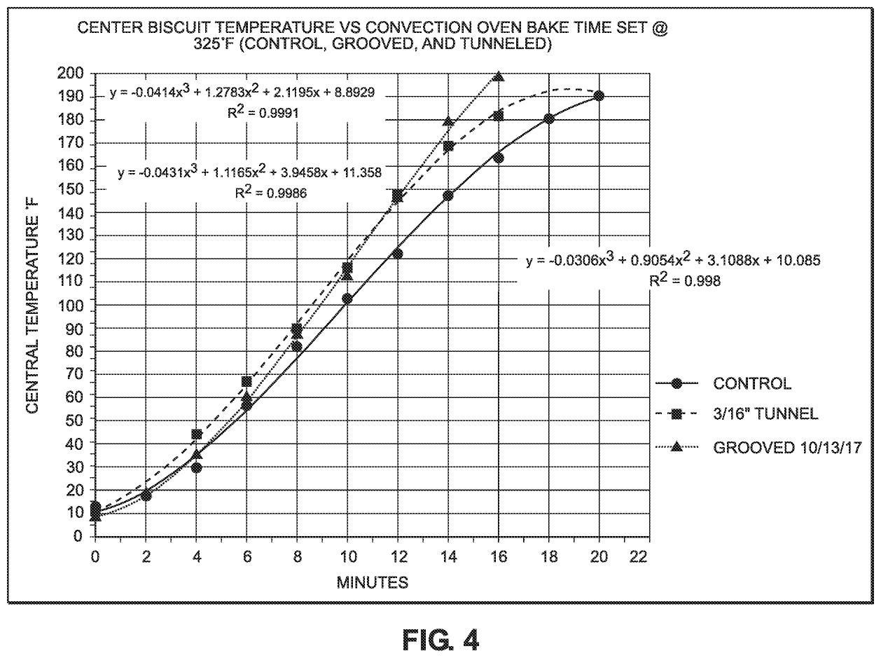

As should be readily apparent from the discussion set forth above, the surface undulation and the tunneling can be employed individually or in combination to provide for, at a minimum, the increased surface area for convection heat transfer during baking and, correspondingly, the reduced freezer to final product cook time. To this end, provided as FIG. 4 is a graph illustrating reduced cooking times associated with certain tested embodiments of the invention. More specifically, the graph illustrates testing of control dough products (conventional dough stamped discs known for making FTO biscuits) vs. undulated or grooved dough products made in accordance with the first embodiment of the invention described above vs. dough products made with tunnels in accordance with the second embodiment of the invention, with each dough product (2 oz biscuits) being baked at 325° F. and considered finally cooked when an internal temperature of 185° F. is reached. As shown, each of the embodiments of the invention was fully baked from a frozen state in significantly less time than the control group.

Based on the above, it should be readily apparent that each of the embodiments of the invention is concerned with creating topological features in a dough piece having a main body portion including an upper surface and a lower surface, wherein the topological features is at least one of undulations in the upper surface created through formation of a series of crest and trough regions and a series of tunnels created in the main body portion of the dough piece, and then freezing the dough piece to produce a frozen dough piece. When the frozen dough pieces are baked, the topological features increase the surface area for convection heat transfer during the baking operation, thereby reducing the overall bake time. Although disclosed with reference to making biscuits, the invention can be employed in making a wide variety of baked dough products. Therefore, although described with reference to certain embodiments, it should be readily understood that various changes and/or modifications may be made in form and detail without departing from the spirit and scope of the invention.

1. A method for producing a topologically modified frozen dough product comprising:
creating topological features in a dough piece having a main body portion including an upper surface and a lower surface, wherein the topological features is at least one of undulations in a majority of the upper surface created through formation of a series of crest and trough regions and a series of tunnels created in the main body portion of the dough piece; and
freezing the dough piece to produce a frozen dough piece.

2. The method of claim 1, further comprising: cooking the frozen dough piece to product the topologically modified dough product.

3. The method of claim 2, wherein cooking the dough piece constitutes heating the dough piece through a convection baking operation with the topological features increasing the surface area, between 10-30% versus a dough piece without the topological features, for convection heat transfer during the baking operation.

4. The method of claim 3, wherein:
the topological features includes the series of crest and trough regions; and
the crest and trough regions define dehydrated, crispy ridges upon baking, resulting in a dual textured baked dough product.

5. The method of claim 4, wherein the lower surface of the main body portion is substantially flat.

6. The method of claim 3, wherein:
the topological features includes the series of tunnels; and
each of the tunnels extends at least 70% through the main body portion.

7. The method of claim 6, further comprising forming the series of tunnels such that each of the tunnels extends at least 90% through the main body portion.

8. The method of claim 6, further comprising fermenting the dough piece during the baking operation, causing expansion of the dough piece and sealing of the series of tunnels.

9. The method of claim 3, wherein the frozen dough piece is a biscuit and the convection baking operation is performed at approximately 325° F., with the biscuit reaching an internal temperature of 185° F. in approximately 20-25% less time than a conventional frozen biscuit.

10. The method of claim 9, wherein forming the dough piece includes:
transporting a dough in the form of a sheet with a conveyor system;
directing the dough through a surface modifying unit to establish the series of crest and trough regions and/or the plurality of tunnels; and
cutting the dough to form the biscuit.

11. The method of claim 1, wherein the topological features include both the undulations in the upper surface through formation of the series of crest and trough regions and the series of tunnels created in the main body portion of the dough piece.

12. A frozen topologically modified dough product comprising a frozen main body portion including an upper surface and a lower surface, wherein the topological features is at least one of: a) undulations in a majority of the upper surface in the form of a series of crest and trough regions; and b) a series of tunnels in the main body portion.

13. The frozen topologically modified dough product according to claim 12, wherein the frozen main body portion includes both the undulations in the upper surface in the form of the series of crest and trough regions and the series of tunnels in the main body.

14. The frozen topologically modified dough product according to claim 12, wherein the topological features includes the series of crest and trough regions.

15. The frozen topologically modified dough product according to claim 12, wherein the topological features includes the series of tunnels, with each of the tunnels extending at least 70% through the main body portion.

16. The frozen topologically modified dough product according to claim 15, wherein each of the tunnels extends at least 90% through the main body portion.

17. The frozen topologically modified dough product according to claim 12, wherein the topological features increase a surface area by between 10-30% versus a correspondingly sized and shaped dough product without the topological features.

18. The frozen topologically modified dough product according to claim 17, wherein the surface area is increased between 15-25%.

19. The frozen topologically modified dough product according to claim 12, wherein the topological features increase a surface area by at least 20% versus a correspondingly sized and shaped dough product without the topological features.
